(19) United States
(12) Patent Application Publication
(10) Pub. No.: US 2004/0190023 A1
(43) Pub. Date: Sep. 30, 2004

(54) Image processing method, apparatus and program

(76) Inventor: Tatsuya Aoyama, Kanagawa-ken (JP)

Correspondence Address: BIRCH STEWART KOLASCH & BIRCH, PO BOX 747, FALLS CHURCH, VA, 22040-0747, US

(21) Appl. No.: 10/793,930

(22) Filed: Mar. 8, 2004

(30) Foreign Application Priority Data
Mar. 25, 2003 (JP) 2003-083528
Mar. 24, 2003 (JP) 2003-081415

(51) Int. Cl. G06T 5/00; H04N 1/409; H04N 1/58

(52) U.S. Cl. 358/1.9; 358/3.26; 358/3.27; 358/1.2; 382/266; 382/275; 382/264

(57) ABSTRACT

An image processing apparatus capable of efficiently performing the noise suppression, sharpness correction, and enlargement processes. A suppressing and correcting means performs the noise suppression and sharpness correction processes on color and gradation processed image data to obtain suppressed and corrected image data. An enlarging means performs the enlarging process on the suppressed and corrected image data to obtain the intended image data.

### BACKGROUND OF THE INVENTION

1. Field of the Invention

The present invention relates to a method, apparatus, and program for implementing image processing that involves adjustment to the high frequency component of image data, and a method, apparatus, and program for performing noise suppression, sharpness correction, and enlargement processes on image data.

2. Description of the Related Art

A variety of systems that provide various services for digital image data (hereinafter referred to as “image data”) have emerged in recent years. Examples such as an image data storage and management service system, in which the image data obtained by scanning a negative film, or obtained by a digital camera is stored and managed, and a printing service system, in which image correction processes are performed on image data to obtain images having desirable image quality before printing, are available today.

In the meantime, most of the systems described above provide services through a network or networks accompanying the rapid popularization of the Internet due to the price reduction of the terminal devices including computers, and the advancement of network technology.

For example, the printing service system described above is configured to print out an image at a printer located, e.g., in a mini-laboratory connected through a network or networks after performing image correction processes on an image data file uploaded to the server from the user terminal, or to store the processed image data in a server with only address information that indicates the location of the file, such as a URL, being sent to the lab so that the lab may download the file thereto for printing when such a request is received. In both cases, the delivery of the image data file from the user terminal to the server or from the server to the printer for printing the image is performed through a network or networks.

In the field of mobile communications, image processing services focusing on personal digital assistants (PDA's) are actively being performed along with the popularization and increased features of the PDA's, such as cellular phones. Some communication exchange servers, for example, have image correction processing functions, including gradation, white balance, density, and sharpness adjustments, and when relaying an e-mail message between two PDA's, an image data file attached to the message sent from the transmitting PDA is processed by these functions before being sent to the receiving PDA, or the processed file is stored in the server with only address information that indicates the location of the file, such as a URL, being sent to the receiving PDA if the PDA cannot receive the attached file, which will be downloaded thereto at a later time when such a request is received. These servers also receive or transmit image data files to PDA's through a network or networks.

These image data files are generally delivered through a network or networks as a compressed image data file in order to reduce the burdens on the terminals and the networks including the reduction in the transmission time. For PDA's, including cellular phones, a particularly tight capacity restriction is imposed and the image data file obtained by the camera attached to the PDA is stored into the storage section of the device after being highly compressed, since most of these image data files will be sent to other PDA's or computers.

The highly compressed image data file described above contains highly visible noise arising from the compression, which must be suppressed. In addition, the compressed image data file lacks sharpness, so that it is desirable to perform a sharpness correction process as well.

The noise arising from the compression includes noise that appears as rippled coding noise due to insufficiency of the high frequency component of an image. This noise is mainly found in the high frequency component of the image and is referred to as mosquito noise since it appears as a mosquito flying on the decoded image.

Japanese Unexamined Patent Publication No. 8(1996)-274996 proposes a method in which a high frequency component of an image is checked to see whether the component is noise or an edge based on the signal level of the high frequency component of the image, and if it is more likely the noise (that is, it is less likely an edge), a smaller enhancement factor or sharpness gain is applied to the high frequency component, when a sharpness correction is performed on the image by performing an enhancement process on the high frequency component of the image. According to this method, the mosquito noise is suppressed, and the sharpness correction may be implemented by sharpening the edge.

Japanese Unexamined Patent Publication No. 2000-299860 proposes another method for removing the noise including the mosquito noise, in which the generation of noise is predicted based on the DCT coefficient of a compressed image compressed by JPEG technology and the like, instead of relying on the signal level of the high frequency component of an image.

Japanese Unexamined Patent Publication No. 7(1995)-307942 proposes a method for removing the mosquito noise by using directional filters adaptively.

In the meantime, it is necessary to enlarge the image for display in order to avoid the problem that the image is too small compared with the screen size if it is displayed on the screen directly due to the rapid spread of PDA's such as cellular phones with built-in cameras with the development of communication technology and improvement of mobile communication networks, and the trend toward larger size and higher screen resolution of the display with the functional enhancement of the PDA. As described above, the image obtained by the camera attached to the PDA is highly compressed, and has a large amount of noise arising from the compression, so that the noise becomes more visible when the image is enlarged. Thus, it is desirable to perform the noise suppression process in addition to the enlargement process. Japanese Unexamined Patent Publication No. 2001-177731 proposes a method in which the enlargement process is applied after color noise is removed in order to speed up the processing, i.e., if the noise suppression process is performed after the enlargement process, longer time is required for the computation due to the larger mask size required for removing the noise and the like, causing a problem of slow processing speed.

However, the image data having a high compression rate obtained by the camera of a cellular phone contains too much noise to determine whether the high frequency component is noise or an edge based only on the signal level thereof, so that the appropriate control of the suppression of the mosquito noise and sharpness enhancement is difficult for the method proposed in the Japanese Unexamined Patent Publication No. 8(1996)-274996.

Further, there may be cases where no DCT coefficients are available and the noise removal method based on the DCT coefficient described in the Japanese Unexamined Patent Publication No. 2000-299860 can not be applied.

Further, the method described in the Japanese Unexamined Patent Publication No. 7(1995)-307942 has a problem that it is structurally complicated, and requires a longer processing time. For example, this method can not be applied to the image attached to a message to be processed and transmitted from one cellular phone to another since such processing and transmission requires extremely prompt processing.

In addition, highly compressed image data has decreased sharpness in addition to conspicuous noise. Therefore, it is also necessary to perform sharpness correction. If a sharpness correction process is performed after an enlargement process, in a processing system that requires enlargement of the image data, calculation time is required for the sharpness correction process, which leads to a problem of slow processing speed.

### SUMMARY OF THE INVENTION

The present invention has been developed in recognition of the circumstance described above, and it is the primary object of the present invention to provide an image processing method, apparatus, and program capable of efficiently suppressing the mosquito noise and correcting the sharpness of an image, with the secondary object of providing an image processing method, apparatus, and program capable of efficiently performing the noise suppression, sharpness correction, and enlargement processes on an image.

The first image processing method of the present invention comprises the steps of:

extracting at least high frequency and mid-frequency components from image data,

setting an evaluation value for the extracted high frequency component, then setting a high frequency component gain for adjusting the extracted high frequency component in accordance with the evaluation value,

adjusting the high frequency component gain by obtaining an edge probability in the extracted mid-frequency component, and in such a way that the lower the edge probability, the lower the high frequency component gain,

adjusting the high frequency component using the adjusted high frequency component gain, and

combining the adjusted high frequency component with other frequency components to obtain the processed image data.

The first image processing apparatus of the present invention comprises:

an extracting means for extracting at least high frequency and mid-frequency components from image data,

a setting means for setting an evaluation value for the extracted high frequency component, then setting a high frequency component gain for adjusting the extracted high frequency component in accordance with the evaluation value,

a gain adjusting means for adjusting the high frequency component gain by obtaining an edge probability in the extracted mid-frequency component, and in such a way that the lower the edge probability, the lower the high frequency component gain,

a high frequency component adjusting means for adjusting the high frequency component using the high frequency component gain adjusted by the gain adjusting means, and

a combining means for combining the high frequency component adjusted by the high frequency component adjusting means with other frequency components to obtain the processed image data.

That is, the present invention makes use of the fact that the mosquito noise is found mainly in the high frequency component and practically not in the mid-frequency component, and the edge is also found in the mid-frequency component, and the high frequency component gain (i.e., adjustment factor) set by the setting means in accordance with the evaluation value for the high frequency component is adjusted based on the edge probability in the mid-frequency component in such a way that the lower the edge probability, the lower the high frequency component gain in implementing the sharpness enhancement process on an image by adjusting the high frequency component of the image.

Preferably, the setting means of the first image processing apparatus of the present invention sets the high frequency component gain greater than that in a case where no adjustment is made to the high frequency component gain in accordance with the edge probability in the mid-frequency component in setting the high frequency component gain based on the evaluation value for the high frequency component. This is in order to avoid the problem of blurred processed image data due to a reduced gain for the edge portion in the high frequency component that may arise when the high frequency component gain is adjusted in accordance with the edge probability in the mid-frequency component.

The gain adjusting means of the first image processing apparatus of the present invention adjusts the high frequency component gain based on the edge probability in the mid-frequency component, and any value may be used for the edge probability as long as it is capable of indicating the probability of an edge portion for the pixel in question in the mid-frequency component. For example, the correlation value of a pixel in at lease a pair of color spaces, each formed of any two colors out of red, green, and blue (RGB) in the mid-frequency component, local dispersion value in the mid-frequency component, and the difference in density obtained by applying an edge detection filter to the mid-frequency component may be used as the edge probability in the mid-frequency component. It is preferable that the absolute signal value of a mid-frequency component be used as the edge probability in the mid-frequency component from the viewpoint of faster calculation.

The first image processing apparatus of the present invention may be adapted to make the adjustment to the mid-frequency component, as well as to the high frequency component, in order to suppress graininess arising from the noise contained in the mid-frequency component. That is, in the first image processing apparatus of the present invention, the extracting means is a decomposing means for decomposing image data into at least high frequency, mid-frequency, and low frequency components, the setting means is a setting means for setting a mid-frequency component gain for adjusting the mid-frequency component by setting an evaluation value for the mid-frequency component, and in accordance with the evaluation value, as well as for setting the high frequency component gain, a mid-frequency component adjusting means is further provided for adjusting the mid-frequency component using the mid-frequency component gain, and the combining means is a combining means for combining the adjusted high frequency and mid-frequency components with other frequency components.

In the present invention, the high frequency, mid-frequency, and low frequency components mean the frequency components having frequency distributions as shown, for example, in FIG. 1. That is, the mid-frequency component is a frequency component having a frequency distribution with its peak in the vicinity of ½ or ⅓ of the Nyquist frequency (6 cycles/mm here) at the output when the processed image data are reproduced as a visible image, the low frequency component is a frequency component having a frequency distribution with its peak at the frequency where Nyquist frequency at the output corresponds to zero, and the high frequency component is a frequency component having a frequency distribution with its peak at the Nyquist frequency at the output.,

Further, the first image processing apparatus of the present invention may further include a luminance component generating means for generating a luminance component of image data, and each of the means of the apparatus described above may be adapted to perform each of the processes on the luminance component to obtain the luminance component processed image data, and the processed image data is obtained based on the luminance component processed image data.

Preferably, the setting means of the first image processing apparatus of the present invention sets the absolute value of the relevant frequency component as the evaluation value of the frequency component. That is, the setting means sets the absolute value of the high frequency component as the evaluation value of the high frequency component, and the absolute value of the mid-frequency component as the evaluation value of the mid-frequency component.

The first program of the present invention is a program for use with a computer that serves as the first image processing apparatus of the present invention, and performs image processing comprising: an extraction process for extracting at least high frequency and mid-frequency components from image data; a setting process for setting an evaluation value for the high frequency component, then setting a high frequency component gain for adjusting the high frequency component in accordance with the evaluation value; a gain adjustment process for adjusting the high frequency component gain by obtaining an edge probability, and in such a way that the lower the edge probability, the lower the high frequency component gain; a high frequency component adjustment process for adjusting the high frequency component using the high frequency component gain adjusted by the gain adjustment process; and a combining process for combining the high frequency component adjusted by the high frequency component adjustment process with other frequency components to obtain the processed image data.

The second image processing method of the present invention is an image processing method for performing noise suppression, sharpness correction, and enlargement processes on image data to obtain the intended image data, wherein the enlargement process is performed after the noise suppression and sharpness correction processes.

That is, the second image processing method of the present invention reduces the processing time by performing the noise suppression, sharpness correction, and enlargement processes on image data in the order in which the enlargement process is performed after the noise suppression and sharpness correction processes.

Here, the known methods including the method using the median filter or unsharp mask may be employed as the noise suppression and sharpness correction methods for image data. The noise suppression and sharpness correction processes may be performed separately or simultaneously. Preferably, the method comprising: an extraction process for extracting at least high frequency and mid-frequency components from image data; a setting process for setting an evaluation value for the high frequency component, then setting a high frequency component gain for emphasizing the high frequency component in accordance with the evaluation value; a gain adjustment process for adjusting the high frequency component gain by obtaining an edge probability in the extracted mid-frequency component, and in such a way that the lower the edge probability, the lower the high frequency component gain; a high frequency component adjustment process for adjusting the high frequency component using the adjusted high frequency component gain; and a combining process for combining the adjusted high frequency component with other frequency components to obtain the processed image data, is used as the method for performing the noise suppression and sharpness correction processes simultaneously. This method makes use of the fact that the mosquito noise is found mainly in the high frequency component and practically not in the mid-frequency component, while the edge is also found in the mid-frequency component, and the suppression of the mosquito noise is implemented simultaneously by adjusting the high frequency component gain based on the edge probability in the mid-frequency component such that the lower the edge probability, the lower the high frequency component gain when the sharpness enhancement is implemented on an image by emphasizing the high frequency component.

Preferably, the high frequency component gain is set greater than that in a case where no adjustment is made to the high frequency component gain in accordance with the edge probability in the mid-frequency component in setting the high frequency component gain based on the evaluation value for the high frequency component. This is in order to avoid the problem of blurred processed image data due to a reduced gain for the edge portion in the high frequency component that may arise when the high frequency component gain is adjusted in accordance with the edge probability in the mid-frequency component.

Any value may be used for the edge probability in the mid-frequency component as long as it is capable of indicating the probability of an edge portion for the pixel in question in the mid-frequency component. For example, the correlation value of a pixel in at least a pair of color spaces, each formed of any two colors out of red, green, and blue (RGB) in mid-frequency component, local dispersion value in the mid-frequency component, and the difference in density obtained by applying an edge detection filter to the mid-frequency component may be used as the edge. probability in the mid-frequency component. It is preferable that the absolute signal value of the mid-frequency component be used as the edge probability in the mid-frequency component from the viewpoint of faster calculation.

In the present invention, the suppression process may be performed on the mid-frequency component in addition to the adjustment process on the high frequency component when the noise suppression and sharpness correction processes are performed. That is, the noise suppression and sharpness correction processes further include a suppression process for suppressing the mid-frequency component of the image data, and the extraction process may be a decomposing process for decomposing an image data into at least high frequency, mid-frequency, and low frequency components, the setting process may be a process for setting an evaluation value for the mid-frequency component, then setting a mid-frequency component gain for suppressing the mid-frequency component in accordance with the evaluation value, as well as for setting the high frequency component gain, the suppression process may be a suppression process for suppressing the mid-frequency component using the mid-frequency component gain, and the combining process may be a combining process for combining the adjusted high frequency component and the suppressed mid-frequency component with other frequency components.

In the present invention, the high frequency, mid-frequency, and low frequency components mean the frequency components having frequency distributions as shown, for example, in FIG. 1. That is, the mid-frequency component is a frequency component having a frequency distribution with its peak in the vicinity of ½ or ⅓ of the Nyquist frequency (6 cycles/mm here) at the output when the processed data is reproduced as a visible image, the low frequency component is a frequency component having a frequency distribution with its peak at the frequency where Nyquist frequency at the output corresponds to zero, and the high frequency component is a frequency component having a frequency distribution with its peak at the Nyquist frequency at the output.

Preferably, the absolute values of the high frequency and mid-frequency components are used as the evaluation values for setting the high frequency and mid-frequency component gains respectively.

The second image processing apparatus of the present invention is an image processing apparatus for performing noise suppression, sharpness correction, and enlargement processes on image data to obtain the intended image data, and comprises: a suppressing and correcting means for performing the noise suppression and sharpness correction processes to obtain the suppressed and corrected image data; and an enlarging means for performing the enlargement process on the suppressed and corrected image data.

Preferably, the suppressing and correcting means comprises: an extracting means for extracting at least high frequency and mid-frequency components from image data; a setting means for setting an evaluation value for the high frequency component, then setting a high frequency component gain for emphasizing the extracted high frequency component in accordance with the evaluation value; a gain adjusting means for adjusting the high frequency component gain by obtaining an edge probability in the extracted mid-frequency component, and such that the lower the edge probability, the lower the high frequency component gain; a high frequency component adjusting means for adjusting the high frequency component using the high frequency component gain adjusted by the gain adjusting means; and a combining means for combining the high frequency component adjusted by the high frequency component adjusting means with other frequency components to obtain the suppressed and corrected image data.

Preferably, the gain adjusting means uses the absolute value of the mid-frequency component as the edge probability in the mid-frequency component.

Preferably, the suppressing and correcting means of the second image processing apparatus of the present invention is a suppressing and correcting means for performing a suppression process on the mid-frequency component as well as for performing the process for adjusting the high frequency component. That is, in the second image processing apparatus of the present invention, it is preferable that the extracting means is a decomposing means for decomposing image data into at least high frequency, mid-frequency, and low frequency components, the setting means is a means for setting an evaluation value for the mid-frequency component, then setting a mid-frequency component gain for adjusting the mid-frequency component in accordance with the evaluation value, as well as for setting the high frequency component gain, suppression means is further provided for suppressing the mid-frequency component using the mid-frequency component gain, and the combining means is a combining means for combining the adjusted high frequency component and suppressed mid-frequency component with other frequency components.

The second program of the present invention is a program for use with a computer for implementing the second image processing method comprising: a procedure for performing the noise suppression and sharpness correction processes on image data to obtain the suppressed and corrected image data; and a procedure for performing the enlargement process on the suppressed and corrected image data to obtain the intended image data.

According to the first image processing method and apparatus of the present invention, the high frequency component gain set on the basis of the evaluation value for the high frequency component is adjusted such that the lower the edge probability in the mid-frequency component, the lower the high frequency component gain. The high frequency component is adjusted using the adjusted high frequency component gain, recognizing the fact that the mosquito noise is found mainly in the high frequency component and not in the mid-frequency component, and the edge is also found in the mid-frequency component, so that the suppression of mosquito noise and sharpness correction maybe implemented more reliably. In addition, the apparatus is structurally simple so that it realizes prompt processing and high efficiency.

The first image processing method and apparatus of the present invention uses the image data itself without requiring any DCT coefficient so that it may also be applied to the image data that do not provide any DCT coefficient such as those obtained by the camera of a cellular phone.

Further, the first image processing apparatus of the present invention uses the absolute value of the mid-frequency component as the edge probability in the mid-frequency component, so that it requires less amount of calculation than in the case where the correlation value or local dispersion value is used, thereby the prompt processing may be realized.

Further, in contrast to the fact that the mosquito noise is mainly found in the high frequency component, there are some noise components which are more likely to be found in the mid-frequency component causing graininess of an image, whereby the image quality is degraded. The first image processing apparatus of the present invention, when adapted to make the adjustment to both the high frequency and mid-frequency components, may also eliminate the graininess of an image arising from the noise contained in the mid-frequency component, as well as suppressing the mosquito noise and correcting the sharpness of the image, so that the processed image data having more favorable image quality may be obtained.

The first image processing apparatus may provide the noise suppression and sharpness correction effects by generating the luminance component based on the image data and making the adjustment only to the luminance component of the high frequency and mid-frequency components when implementing the adjustment to the high frequency and mid-frequency components, since the component of color difference has little influence on the sharpness of the image; and thereby the amount of calculation required for the processing may be reduced.

According to the second image processing method and apparatus, the enlargement process is performed after the noise suppression and sharpness correction processes in obtaining the intended image data by performing the noise suppression, sharpness correction, and enlargement processes, so that less amount of calculation is required for the noise suppression and sharpness correction processes, resulting in a reduced processing time and high efficiency.

Further, the second image processing apparatus may implement the suppression of the mosquito noise and sharpness correction simultaneously by adjusting the high frequency component gain set based on the evaluation value for the high frequency component such that the lower the edge probability in the mid-frequency component, the lower the high frequency component gain, and adjusting the high frequency component using the adjusted high frequency component gain, recognizing the fact that the mosquito noise is found mainly in the high frequency component and not in the mid-frequency component, while the edge is also found in the mid-frequency component. In addition, the apparatus is structurally simple so that it realizes prompt processing and results in high efficiency.

Further, in contrast to the fact that the mosquito noise is mainly found in the high frequency component, there are some noise components which are more likely to be found in the mid-frequency component causing graininess of an image, whereby the image quality is degraded. The second image processing apparatus of the present invention, when adapted to perform the suppression process on the mid-frequency component in addition to the adjustment process on the high frequency component as the noise suppression and sharpness correction processes, may also eliminate the graininess of an image arising from the noise component found in the mid-frequency component, as well as suppressing the mosquito noise and correcting the sharpness of the image, so that the image quality may be improved.

### BRIEF DESCRIPTION OF THE DRAWINGS

FIG. 1 is a drawing illustrating the low frequency, mid-frequency, and high frequency components.

FIG. 2 is a block diagram illustrating the configuration of the image processing apparatus according to an embodiment of the present invention.

FIG. 3A is a block diagram illustrating the configuration of the mid-frequency component processing means 20 shown in FIG. 2.

FIG. 3B is a block diagram illustrating the configuration of the high frequency component processing means 30 shown in FIG. 2.

FIG. 4 is a drawing illustrating a table T1 for setting the mid-frequency component gain GM.

FIG. 5 is a drawing illustrating a table T2 for setting the mid-frequency component gain GH0.

FIG. 6 is a drawing illustrating a table T0 for adjusting the high frequency component gain GH0.

FIG. 7 is a flow chart illustrating the operation of the image processing apparatus according to the embodiment shown in-FIG. 2.

FIG. 8 is a flow chart illustrating the operation of the mid-frequency component processing means 20 shown in FIG. 3A.

FIG. 9 is a flow chart illustrating the operation of the high frequency component processing means 30 shown in FIG. 3B.

FIG. 10 is a drawing illustrating another example of the table T2 for setting the high frequency component gain GH0.

### DESCRIPTION OF THE PREFERRED EMBODIMENTS

Hereinafter, the preferred embodiments of the present invention will be described with reference to the accompanying drawings.

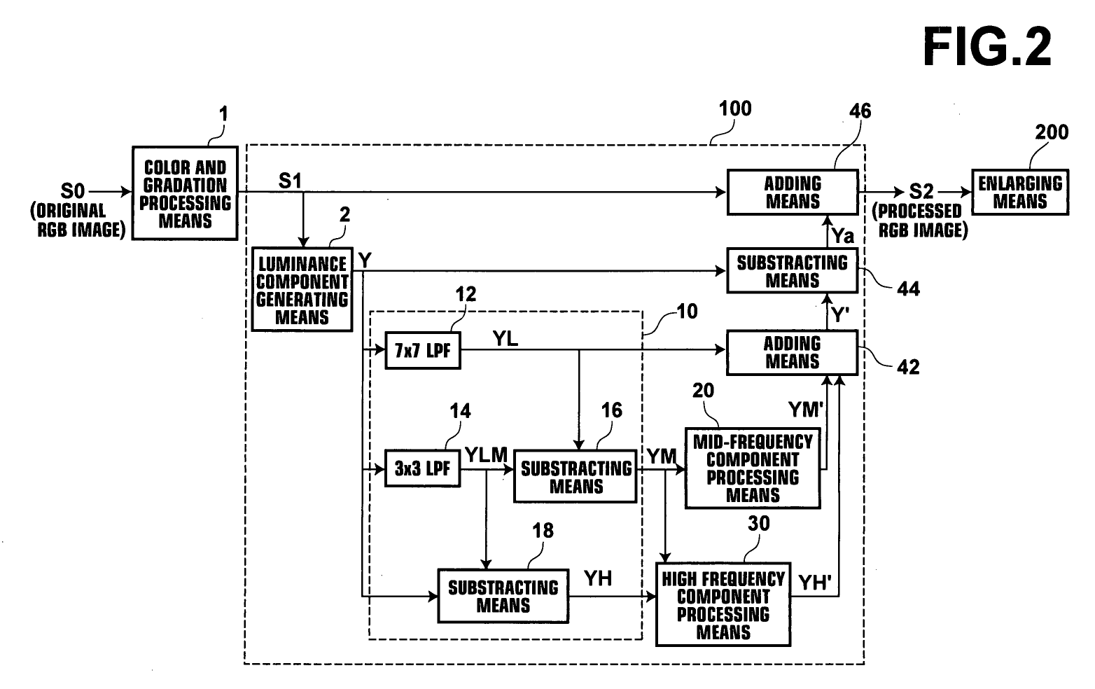

FIG. 2 is a block diagram illustrating the configuration of the image processing apparatus according to an embodiment of the present invention. As shown in FIG. 2, the image processing apparatus according to the embodiment comprises: a color and gradation processing means 1 for processing the color and gradation of image data S0, which are 3-color data of RGB, to obtain the color and gradation processed image data S1; a suppressing and correcting means 100 for performing the noise suppression and sharpness correction processes on the color and gradation processed image data S1 to obtain the suppressed and corrected image data S2; and an enlarging means 200 for performing the enlargement process on the suppressed and corrected image data S2 to obtain the intended image data S3.

The color and gradation processing means 1 determines the parameters for adjusting the color and gradation of the image data S0 based on the image data S0, and adjusts the color and gradation of the image data S0 using the parameters to obtain the color and gradation adjusted image data S1.

The suppressing and correcting means 100 comprises a luminance component generating means 2 for generating a luminance component Y from the RGB data forming the color and gradation processed image data S1; a decomposing means 10 for decomposing the luminance component Y into high frequency component YH, mid-frequency component YM, and low frequency component YL; a mid-frequency component processing means 20 for processing the mid-frequency component YM to obtain a processed mid-frequency component YM′; a high frequency component processing means 30 for processing the high frequency component YH to obtain a processed high frequency component YH′; an adding means 42 for adding the low frequency component YL, processed mid-frequency component YM′, and processed high frequency component YH′ together to obtain a processed luminance component Y′; a subtracting means 44 for subtracting the luminance component Y generated by the luminance component generating means 2 from the processed luminance component Y′ to obtain a value Ya of luminance difference; and an adding means 46 for adding the value Ya of luminance difference to the image data S1 obtained by the color and gradation processing means 1 to obtain the suppressed and corrected image data S2 which are the three color data of RGB.

The luminance component generating means 2 generates the luminance component Y by performing the arithmetic operation shown in the Formula (1) below on the RGB color data of R1, G1, and B1 forming the image data S1.

Y=0.3R1+0.59G1+0.11B1 (1)

The decomposing means 10 comprises a filtering means 12 for filtering the luminance component Y with a 7×7 low pass filter (LPF) to obtain the low frequency component YL of the luminance component Y; a filtering means 14 for filtering the luminance component Y with a 3×3 low pass filter to obtain a low and mid-frequency component YLM of the luminance component Y; a subtracting means 16 for subtracting the low frequency component YL from the low and mid-frequency component YLM in accordance with the Formula (2) below to obtain the mid-frequency component YM; and a subtracting means 18 for subtracting the low and mid-frequency component YLM from the luminance component Y in accordance with the Formula (3) below to obtain the high frequency component YH.

YM=YLM−YL (2)

YH=Y−YLM (3)

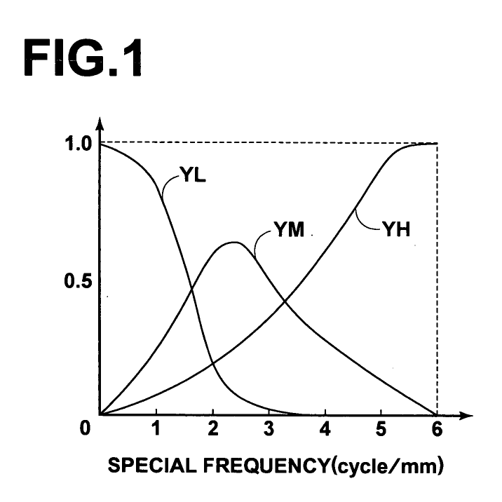

Here, the low frequency component YL, mid-frequency component YM, and high frequency component YH mean frequency components having frequency distributions as shown in FIG. 1. That is, the mid-frequency component YM is a frequency component having a frequency distribution with its peak in the vicinity of ½ or ⅓ of the Nyquist frequency (6 cycles/mm here) at the output when the suppressed and corrected image data S2 are reproduced as a visible image, the low frequency component YL is a frequency component having a frequency distribution with its peak at zero frequency, and the high frequency component is a frequency component having a frequency distribution with its peak at the Nyquist frequency at the output.

Here, the luminance component Y is decomposed into three frequency components as an example, but the number of the decomposition is not limited to three, and it maybe decomposed into more than three frequency components. When the luminance component Y is decomposed into more than three frequency components in this manner, the low, mid, and high frequency components are selected from a plurality of frequency components.

The mid-frequency component processing means 20 sets a mid-frequency component gain GM, and multiplies the mid-frequency component by the mid-frequency component gain GM in accordance with Formula (4) below to obtain the processed mid-frequency component YM′, and the high frequency component processing means 30 sets a high frequency component gain GH, and multiplies the high frequency component by the high frequency component gain GH in accordance with Formula (5) below to obtain the processed high frequency component YH′.

YM′=YM×GM (4)

YH′=YH×GH (5)

Hereinafter, the configuration of the mid-frequency component processing means 20 and the high frequency component processing means 30 will be described in more detail.

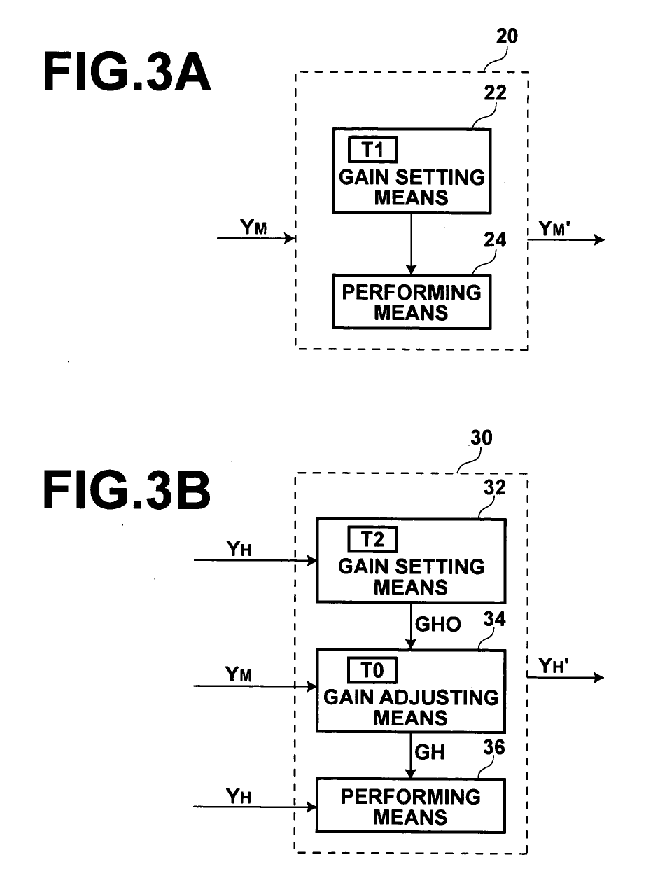

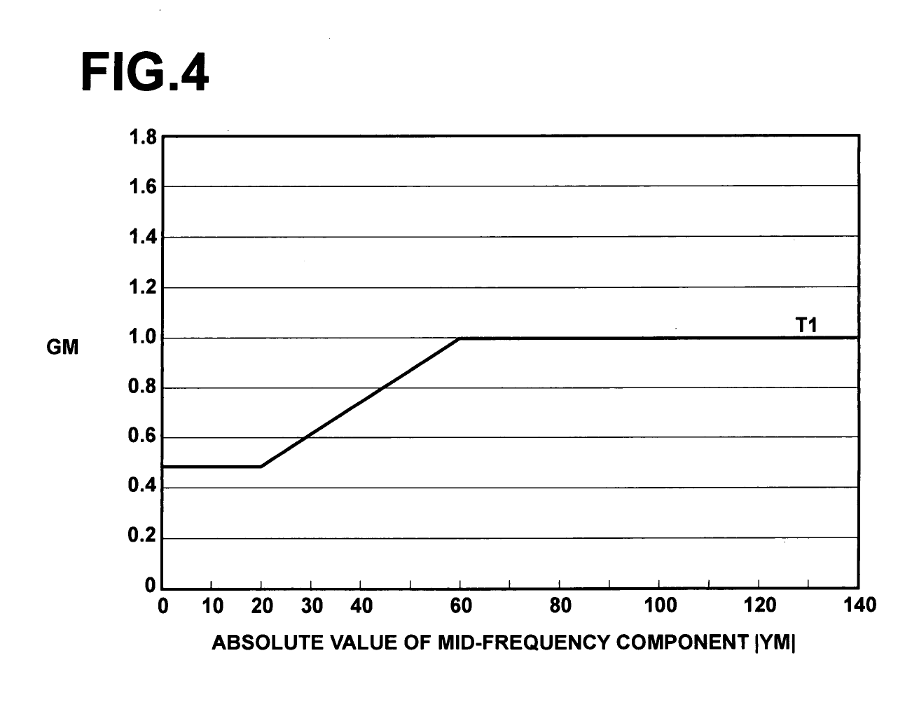

FIGS. 3A and 3B are the block diagrams illustrating the configuration of the mid-frequency component processing means 20 and high frequency component processing means 30 respectively. As shown in FIG. 3A, the mid-frequency component processing means 20 of the image processing apparatus shown in FIG. 2 has a gain setting means 22 for setting the gain GM used for multiplying the mid-frequency component YM, and a executing means 24 for executing the arithmetic operation shown in Formula 4 above, in which the mid-frequency component YM is multiplied by the gain GM obtained by the gain setting means 22, to obtain the processed mid-frequency component YM′. More specifically, the gain setting means 22 determines the absolute value |YM| of the mid-frequency component as the evaluation value for the mid-frequency component YM, and sets the mid-frequency component gain GM according to the table T1 shown in FIG. 4 based on the absolute value obtained.

FIG. 4 shows the table T1 indicating the relationship between the absolute value |YM| of the mid-frequency component and gain GM. As shown in the figure, the mid-frequency component gain GM is set such that the mid-frequency component YM for the pixel having a smaller absolute value |YM| of the mid-frequency component YM than a predetermined threshold value (20 in this example) is more significantly suppressed than the mid-frequency component YM for the pixel having a higher absolute value |YM| than the predetermined threshold value.

In the image data obtained from an image recorded on a film with a scanner or similar device, the graininess arising from the film graininess is mainly found in the mid-frequency component of the image. However, this graininess is particularly noticeable in the image arising from the graininess of the region corresponding to the vicinity of the boundary between the mid and low frequency components. This graininess is represented by a comparatively a small value as the absolute value of the mid-frequency component. Likewise, in an image represented by the image data S0 obtained by a digital camera, the graininess arising from the small signal in the similar frequency band is particularly noticeable. For this reason, the mid-frequency component processing means 20 according to this embodiment is adapted to suppress the mid-frequency component YM such that the mid-frequency component YM for the pixel having a smaller absolute value |YM| of the mid-frequency component YM than the predetermined threshold value is more significantly suppressed than the mid-frequency component YM for the other pixels having a higher absolute value |YM| than the predetermined threshold value. This effectively suppresses the highly noticeable graininess based on the assumption that the pixel having a smaller absolute value |YM| than the predetermined threshold value corresponds to the noticeable graininess.

The gain setting means 22 of the mid-frequency component processing means 20 sets the gain GM for the mid-frequency component YM in this manner by referring to the table T1 shown in FIG. 4, which is supplied to the executing means 24.

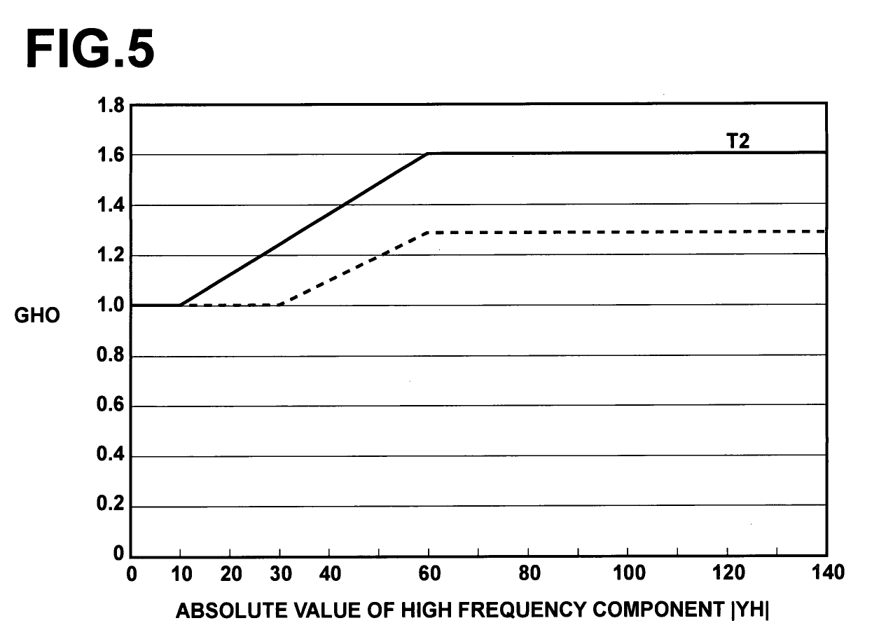

FIG. 3B is a block diagram illustrating the configuration of the high frequency component processing means 30. As shown in the FIG. 3A, the high frequency component processing means 30 of the image processing apparatus shown in FIG. 2 has a gain setting means 32 for setting the gain GH0 used for multiplying the high frequency component YH; a gain adjusting means 34 for adjusting the gain GH0 obtained by the gain setting means 32 to obtain the high frequency component gain GH; and a executing means 36 for executing the arithmetic operation in which the high frequency component YH is multiplied by the gain GH obtained by the gain adjusting means 34 by adjusting the gain GH0 in accordance with Formula (5) above to obtain the processed high frequency component YH′. More specifically, the gain setting means 32 determines the absolute value |YH| of the high frequency component as the evaluation value for the high frequency component YH, and sets the high frequency component gain GH0 according to the table T2 shown in FIG. 5 based on the absolute value.

FIG. 5 shows the table T2 that indicates the relationship between the absolute value |YH| of the high frequency component YH and gain GH0. The dotted line in the figure indicates the table used to emphasize the high frequency component for the ordinary image processing apparatus. The gain setting means of the image processing apparatus according to the embodiment of the present invention sets the high frequency component gain GH0 higher than that in a case where no adjustment is made to the high frequency component gain in accordance with the edge probability in the mid-frequency component as shown in the table T2. This is in order to avoid the problem of blurred processed image data due to a reduced gain for the edge portion in the high frequency component that may arise when the high frequency component gain is adjusted in accordance with the edge probability in the mid-frequency component.

As shown in FIG. 5, the high frequency component gain GH0 is set such that the high frequency component YH for the pixel having a smaller absolute value |YH| of the high frequency component YH than a predetermined threshold value (10 in this example) is less emphasized than the high frequency component YH for the pixel having a higher absolute value |YH| than the predetermined threshold value. The reason is that the small signal contained in the high frequency component is likely to cause the graininess. The gain setting means 32 according to this embodiment emphasizes the high frequency component, but if the absolute value |YH| of the high frequency component YH for a pixel is smaller than the predetermined threshold value, a lower emphasis level (or gain GH0) is assigned to the pixel than the other pixels having a higher absolute value |YH| of the high frequency component YH than the. predetermined threshold value. This is to avoid emphasizing the graininess at the time of emphasizing (or correcting) the sharpness.

The gain setting means 32 of the high frequency component processing means 30 sets the high frequency component gain GH0 in this manner by referring to the table T2 shown in FIG. 5.

The gain GH0 set by the gain setting means 32 is adjusted by the gain adjusting means 34 before being supplied to the executing means 36.

The gain adjusting means 34 sets an adjustment factor α in accordance with the absolute value |YM| of the mid-frequency component YM regarding it as the edge probability in the mid-frequency component, and adjusts the gain GH0 to obtain the high frequency component gain GH by multiplying the gain GH0 set by the gain setting means 32 by the adjustment factor α in accordance with Formula 6 below.

GH=GH0×α (6)

where α is the adjustment factor

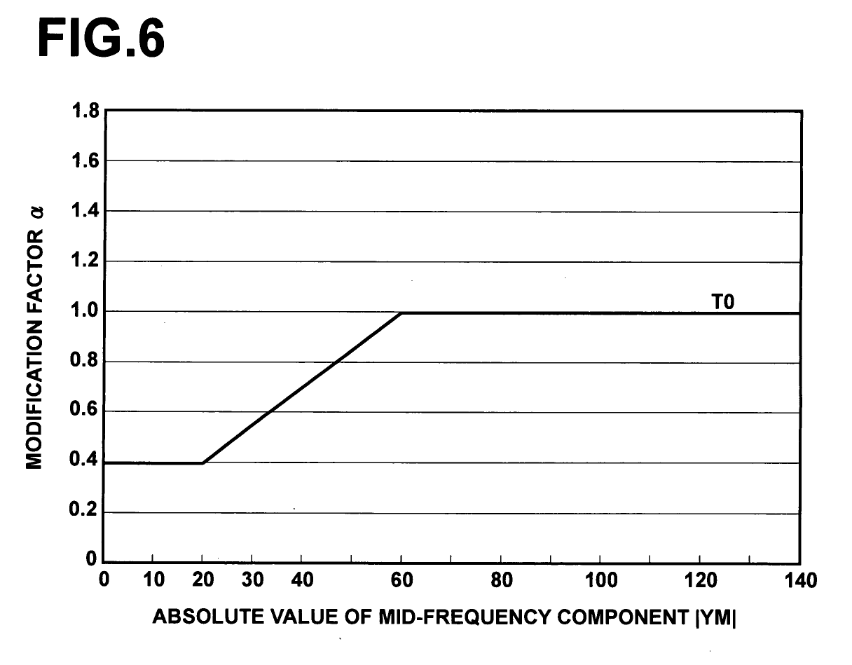

FIG. 6 is a drawing showing a table T0 that indicates the relationship between the adjustment factor α for the high frequency component gain GH0 set by the gain setting means 32 and the absolute value |YM| of the mid-frequency component YM. As shown in the figure, the adjustment factor α is set such that the gain GH0 for the pixel having a smaller absolute value |YM| of the mid-frequency component YM (i.e., the pixel with a low edge probability and high noise probability) than the predetermined first threshold value (20 in this example) is adjusted more significantly than the gain GH0 for the pixel having a higher absolute value |YM| (i.e., the pixel with a comparatively higher edge probability and lower noise probability) . That is, the adjustment factor α is set such that the lower the edge probability in the mid-frequency component, the lower the high frequency component gain. The reason is that the mosquito noise may be suppressed by enhancing the decreasing operation for the high frequency component gain GH0 for the pixel having a low edge probability, since the mosquito noise mainly found in the high frequency component is not found in the mid-frequency component or appears as a small signal. Therefore, the pixel having a lower edge probability in the mid-frequency component has a higher probability of mosquito noise. On the other hand, the sharpness correction with sharpness enhancement may be performed effectively by lessening the decreasing operation for the high frequency component gain GH0 for the pixel having a high edge probability together with the suppression of the mosquito noise.

In the meantime, for the pixel having a higher absolute value of the mid-frequency component than a predetermined second threshold value (60 in this example), the adjustment factor α is set to 1 in order that the high frequency component gain GH0 for the pixel is not decreased since such pixel has no probability of being noise.

The gain adjusting means 34 sets the adjustment factor α in accordance with the absolute value |YM| of the mid-frequency component YM in this manner by referring to the table T0 shown in FIG. 6, and adjusts the gain GH0 by multiplying the GH0 set by the gain setting means 32 by the adjustment factor a to obtain the high frequency component gain GH in accordance with Formula (6) described above.

The executing means 36 of the high frequency component processing means 30 performs the arithmetic operation, in which the high frequency component YH is multiplied by the gain GH obtained by the gain adjusting means 34 in accordance with Formula (5) described above, to obtain the processed high frequency component YH′.

The adding means 42 adds the low frequency component YL obtained by the filtering means 12, processed mid-frequency component YM′ obtained by the mid-frequency component processing means 20, and the processed high frequency component YH′ obtained by the high frequency component processing means 30 together to obtain the processed luminance component Y′. The subtracting means 44 subtracts the luminance component Y generated by the luminance component generating means 2 from the processed luminance component Y′ to obtain the value Ya of luminance difference. Then, the adding means 46 adds the value Ya of luminance difference to each of the color data R1, G1, and B1 forming the image data S1 to obtain the color data R2, G2, and B2 forming the suppressed and corrected imaged data S2.

R2=R1+Ya

G2=G1+Ya (7)

B2=B1+Ya

The enlarging means 200 performs an enlargement process on the suppressed and corrected image data S2 obtained by the suppressing and correcting means 100 to obtain the intended image data S3. Here, the enlargement process by the enlarging means 200 is performed using a variety of known techniques such as cubic spline interpolation, B-spline interpolation, linear interpolation, or interpolation using a renewed interpolation factor obtained by adding interpolation factors of two interpolations having different sharpness degrees (for example, the cubic spline interpolation having a high degree of sharpness and B-spline interpolation having a low degree of sharpness) after being weighted.

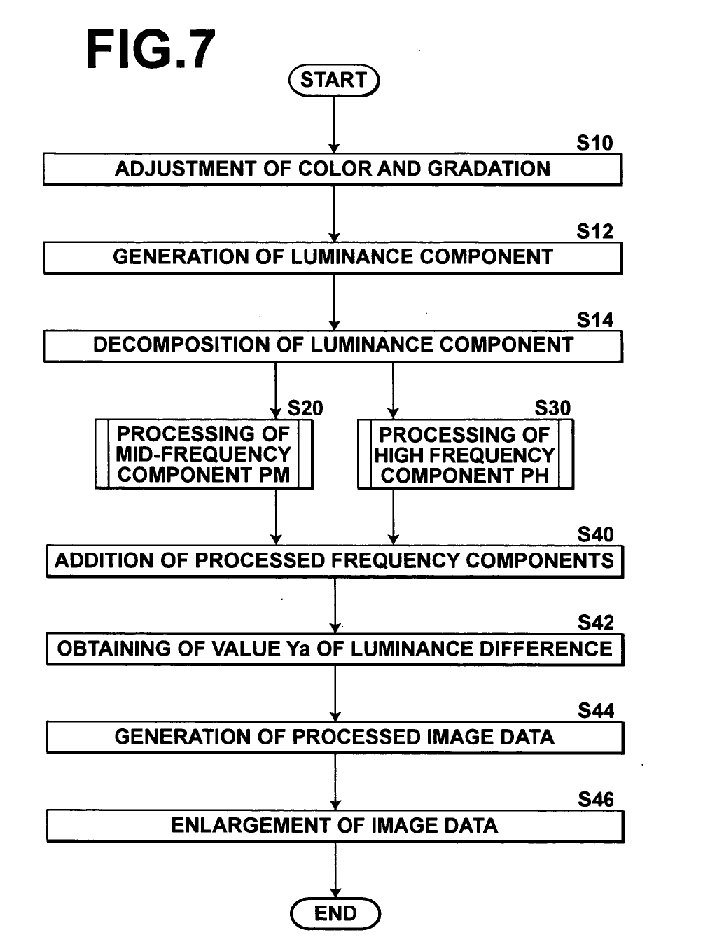

The operation of the image processing apparatus of the embodiment will be described hereinbelow. FIG. 7 is a flow chart illustrating the operation of the image processing apparatus according to the embodiment. As shown in the figure, in the image processing apparatus according to the embodiment, the color and gradation adjustment process is performed first on the image data S0 by the color and gradation processing means 1 to obtain the color and gradation adjusted image data S1 (S10) Then the luminance component Y is generated based on the image data S1 by the luminance component generating means 2 (S12), and the luminance component Y is decomposed into the low frequency component YL, mid-frequency component YM, and high frequency component YH by the decomposing means 10 (S14). Mid-frequency component processing PM, in which the mid-frequency component YM is suppressed, is performed on the mid-frequency component YM by the mid-frequency component processing means 20 to obtain the processed mid-frequency component YM′ (S20), and high frequency component processing PH, in which the high frequency component YH is adjusted, is performed on the high frequency component YH by the high frequency component processing means 30 to obtain the processed high frequency component YH′ (S30). The low frequency component YL, processed mid-frequency component YM′, and processed high frequency component YH′ are added together by the adding means 42 to obtain the processed luminance component Y′ (S40) The luminance component Y generated by the luminance component generating means 2 is subtracted from the processed luminance component Y′ to obtain the value Ya of luminance difference (S42) . Finally, the value Ya of luminance difference is added by the adding means 46 to each of the color data R1, G1, and B1 of the image data S1 obtained by the color and gradation processing means 1 to obtain the color data R2, G2, and B2 forming the suppressed and corrected image data S2 (S44). The enlargement process is performed by the enlarging means on the suppressed and corrected image data S2 obtained by the suppressing and correcting means 100 (S46).

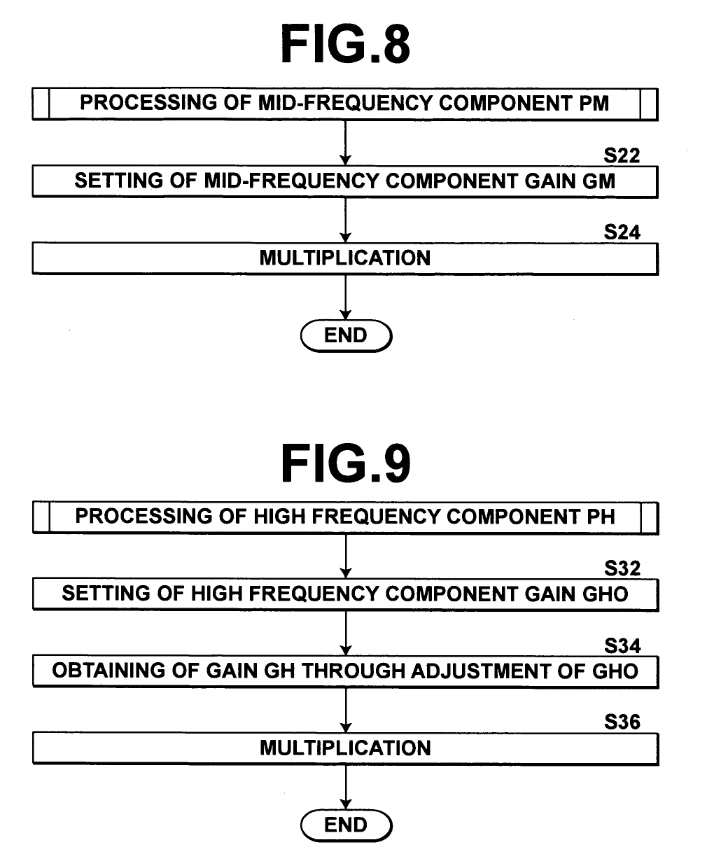

FIG. 8 is a flow chart illustrating specifically the mid-frequency component processing PM (S20) performed by the mid-frequency component processing means 20. As shown in the figure, the mid-frequency component gain GM is set first by the gain setting means 22 in accordance with the absolute value |YM| of the mid-frequency component YM by referring to the table T1 shown in FIG. 4 (S22), and the mid-frequency component YM is multiplied by the mid-frequency component gain GM by the executing means 24 to obtain the processed mid-frequency component YM′ (S24).

FIG. 9 is a flow chart illustrating specifically the high frequency component processing PH (S30) performed by the high frequency component processing means 30. As shown in the figure, the high frequency component gain GH0 is set first by the gain setting means 32 in accordance with the absolute value |YH| of the high frequency component YH by referring to the table T2 shown in FIG. 5 (S32). Then the adjustment factor α for adjusting the high frequency component gain is set in accordance with the mid-frequency component YM by referring to the table T0 shown in FIG. 6, and the gain GH0 set by the gain setting means 32 in step S32 is multiplied by the adjustment factor α to adjust the gain GH0 by the gain adjusting means 34 to obtain the high frequency component gain GH (S34). The high frequency component YH is multiplied by the high frequency component gain GH by the executing means 36 to obtain the processed high frequency component YH′ (S36).

As described above, the image processing apparatus according to the embodiment performs the enlargement process after the noise suppression and sharpness correction processes in performing the noise suppression, sharpness correction and enlargement processes on image data, so that the calculation time required for the noise suppression and sharpness correction may be reduced, whereby the image processing efficiency may be improved.

Further, the image processing apparatus according to the embodiment adjusts the high frequency component gain GH0 set based on the evaluation value for the high frequency component YH such that the lower the edge probability in the mid-frequency component YM, the lower the gain GH0, and adjusts the high frequency component YH using the adjusted high frequency component gain GH when the sharpness correction is implemented by adjusting the high frequency component, so that the suppression of the mosquito noise and sharpness correction may be implemented more reliably. At the same time, the apparatus is structurally simple so that it may realize prompt processing and high efficiency.

Further, the apparatus uses the image data itself without requiring any DCT coefficient, so that it may also be applied to the image data that do not provide any DCT coefficient such as those obtained by the camera of a cellular phone.

Further, the apparatus uses the absolute value |YM| of the mid-frequency component YM as the edge probability in the mid-frequency component, so that it may provide more prompt processing with less amount of calculation.

Further, the image processing apparatus according to the embodiment, when adapted to make the adjustment to both the high frequency component YH and mid-frequency component YM, may also eliminate the graininess of an image arising from the noise contained in the mid-frequency component, in addition to suppressing the mosquito noise and correcting the sharpness of the image, so that the processed image data having more favorable image quality may be obtained.

Further, the apparatus makes use of the fact that the component of color difference has little influence on the sharpness of an image and may provide the noise suppression and sharpness adjustment effects by generating the luminance component based on the image data and making the adjustment only to the luminance component of the high frequency and mid-frequency components when implementing the adjustment to the high frequency and mid-frequency components, thereby the amount of calculation required for the processing may be reduced and improved efficiency may be realized.

Further, the apparatus uses the absolute values |YM| and |YH| as the evaluation values for the mid-frequency and high frequency components respectively when setting the mid-frequency component gain GM and high frequency component gain GH0, so that further reduction in the amount of calculation may be achieved.

An embodiment of the present invention has been described above, but the image processing apparatus and program of the present invention are not limited to the embodiment described above; and various changes, modifications, additions and subtractions may be made thereto without departing from the spirit or essential characteristic thereof.

For example, in the image processing apparatus according to the embodiment described above, the luminance component Y is generated from the image data S1, and the mid-frequency component YM and high frequency component YH contained in the luminance component Y are multiplied by the gain GM and GH respectively. However, the apparatus may be adapted to obtain mid-frequency components RM, GM, and BM, and high frequency components RH, GH, and BH from each of the color data R1, G1, and B1 forming the image data S1, and generate processed mid-frequency components RM′, GM′, and BM′, and processed high frequency components RH′, GH′, and BH′ for each of the colors to obtain the suppressed and corrected image data S2. In this case, the gains the mid-frequency components RM, GM, and BM are multiplied by may be set based on the absolute values of the mid-frequency components RM, GM, and BM, and the gains the high frequency components RH, GH, and BH are multiplied by may be set based on the absolute values of the high frequency components RH, GH, and BH, and adjusted in accordance with the absolute values of mid-frequency components RM, GM, and BM.

In the image processing apparatus according to the embodiment described above, the image data S0 is assumed to be formed of RGB data, but the apparatus may also be applied to the image data S0 formed of standard color space data such as YCC, Lab, and the like. For the standard color space data, the luminance component is already in existence and available for use with the apparatus, so that the apparatus may implement the image processing without generating the luminance component from the image data S0.

Further, in the image processing apparatus according to the embodiment described above, the suppression process is implemented on the mid-frequency component to eliminate the graininess arising from the noise contained in the mid-frequency component in addition to performing the adjustment process on the high frequency component, but the present invention may be applied to any image processing, in which the adjustment to the high frequency component is required but the suppression of the mid-frequency component is not necessarily required. In such a case, the apparatus may efficiently implement the suppression of the mosquito noise and sharpness enhancement by performing the adjustment process on the high frequency component using the adjusted enhancement factor for the high frequency component in accordance with the edge probability in the mid-frequency component as described above.

Further, the method for generating the luminance component is not limited to the scheme of Formula (1) above. For example, the average value of R, G, and B ((R+G+B)/3) may be generated as the luminance component.

The filters for obtaining each of the frequency components may be any filter as long as it has a decomposing capability for frequency components, and are not limited to the 7×7 low pass filter used for the filtering means 12 and 3×3 low pass filter used for the filtering means 14. In addition, the size of each of the filters may be changed in accordance with the image size, screen resolution of a device for displaying the image (e.g., a monitor), type of printing medium used, for example, with a printer for printing out the image, with or without scaling, etc.

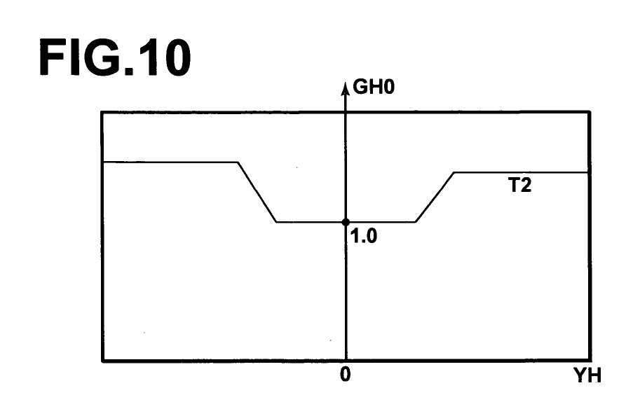

The table T1 used by the gain setting means 22 for setting the mid-frequency component gain GM, and the table T2 used by the gain setting means 32 for setting the high frequency component gain GH0 are not limited to the tables according to the absolute value of the mid-frequency component and that of the high frequency component as shown in FIGS. 4 and 5 respectively. For example, they may be the value of the mid-frequency component and that of the high frequency component instead of the absolute values thereof, respectively. The use of such tables allows the use of different adjustment factors (gains) on the low and high density portions. For example, when the gain GH0 for the low density portion (YH<0) is set higher than the gain GH0 for the high density portion (YH>0) having the same absolute value as that of the low density portion as in the table shown in FIG. 10 which is in accordance with the luminance value YH of the high frequency component, the edge in the low density portion of an image is adjusted (emphasized in the example shown in the figure) more significantly than that in the high density portion of the image, so that a different sharpness correction effect from that obtained with the table T2 in FIG. 5 may be obtained for the processed image. FIG. 10 shows an example of the high frequency component, but the same applies to the mid-frequency component.

Further, in the image processing apparatus according to the embodiment described above, the noise suppression and sharpness correction processes are performed simultaneously for prompt image processing, but they may be implemented separately by the second image processing method and apparatus of the present invention. In addition, the various known methods may be applied to the noise suppression and sharpness correction processes.

The low pass filters used for extracting the mid-frequency and high frequency components are not limited to those used in the image processing apparatus according to the embodiment described above. They may be any filter with different sizes and other properties, as long as they are capable of extracting the mid-frequency and high frequency components.

What is claimed is:

1. An image processing method comprising the steps of:
extracting at least high frequency and mid-frequency components from image data;
setting an evaluation value for said high frequency component, then setting a high frequency component gain for adjusting said extracted high frequency component in accordance with said evaluation value;
adjusting said high frequency component gain by obtaining an edge probability in said extracted mid-frequency component, and in such a way that the lower said edge probability, the lower said high frequency component gain;
adjusting said high frequency component using said adjusted high frequency component gain; and
combining said adjusted high frequency component with other frequency components to obtain the processed image data.

2. An image processing method for performing noise suppression, sharpness correction, and enlargement processes on image data to obtain the intended image data, wherein said enlargement process is performed after said noise suppression and sharpness correction processes.

3. The image processing method according to claim 2, wherein said noise suppression and sharpness correction processes comprise:
an extraction process for extracting at least high frequency and mid-frequency components from image data;
a setting process for setting an evaluation value for said extracted high frequency component, then setting a high frequency component gain for emphasizing said high frequency component in accordance with said evaluation value;
a gain adjustment process for adjusting said high frequency component gain by obtaining an edge probability in said extracted mid-frequency component, and in such a way that the lower said edge probability, the lower said high frequency component gain;
a high frequency component adjustment process for adjusting said high frequency component using said adjusted high frequency component gain; and
a combining process for combining said adjusted high frequency component with other frequency components.

4. The image processing method according to claim 3, wherein an absolute signal value of said mid-frequency component is used as said edge probability in said mid-frequency component in performing said gain adjustment process.

5. The image processing method according to claim 3, wherein said noise suppression and sharpness correction processes further include a suppression process for suppressing said mid-frequency component of said image data, and
said extraction process is a decomposing process for decomposing said image data into at least said high frequency component, said mid-frequency component, and a low frequency component;
said setting process is a setting process for setting an evaluation value for said mid-frequency component, then setting a mid-frequency component gain for suppressing said decomposed mid-frequency component in accordance with said evaluation value, as well as for setting said high frequency component gain;
said suppression process performs a suppression process for suppressing said mid-frequency component using said mid-frequency component gain; and
said combining process is a combining process for combining said adjusted high frequency component and said suppressed mid-frequency component with other frequency components.

6. The image processing method according to claim 4, wherein said noise suppression and sharpness correction processes further include a suppression process for suppressing said mid-frequency component of said image data, and
said extraction process is a decomposing process for decomposing said image data into at least said high frequency component, said mid-frequency component, and a low frequency component;
said setting process is a setting process for setting an evaluation value for said mid-frequency component, then setting a mid-frequency component gain for suppressing said decomposed mid-frequency component in accordance with said evaluation value, as well as for setting said high frequency component gain;
said suppression process performs a suppression process for suppressing said mid-frequency component using said mid-frequency component gain; and
said combining process is a combining process for combining said adjusted high frequency component said suppressed mid-frequency component with other frequency components.

7. An image processing apparatus comprising:
an extracting means for extracting at least high frequency and mid-frequency components from image data;
a setting means for setting an evaluation value for said high frequency component, then setting a high frequency component gain for adjusting said extracted high frequency component in accordance with said evaluation value;
a gain adjusting means for adjusting said high frequency component gain by obtaining an edge probability in said extracted mid-frequency component, and in such a way that the lower said edge probability, the lower said high frequency component gain;
a high frequency component adjusting means for adjusting said high frequency component using said high frequency component gain adjusted by said gain adjusting means; and
a combining means for combining said high frequency component adjusted by said high frequency component adjusting means with other frequency components to obtain the processed image data.

8. The image processing apparatus according to claim 7, wherein said gain adjusting means uses an absolute signal value of said mid-frequency component as said edge probability in said mid-frequency component.

9. The image processing apparatus according to claim 7, wherein
said extracting means is a decomposing means for decomposing image data into at least high frequency, mid-frequency, and low frequency components;
said setting means is a setting means for setting an evaluation value for said extracted mid-frequency component, then setting a mid-frequency component gain in accordance with said evaluation value, as well as for setting said high frequency component gain;
a mid-frequency component adjusting means is further provided for adjusting said mid-frequency component using said mid-frequency component gain; and
said combining means is a combining means for combining said adjusted high frequency and mid-frequency components with other frequency components.

10. The image processing apparatus according to claim 8, wherein
said extracting means is a decomposing means for decomposing image data into at least high frequency, mid-frequency, and low frequency components;
said setting means is a setting means for setting an evaluation value for said extracted mid-frequency component, then setting a mid-frequency component gain in accordance with said evaluation value, as well as for setting said high frequency component gain;
a mid-frequency component adjusting means is further provided for adjusting said mid-frequency component using said mid-frequency component gain; and
said combining means is a combining means for combining said adjusted high frequency and mid-frequency components with other frequency components.

11. The image processing apparatus according to claim 7, wherein a luminance component generating means is further provided, and each of said means performs each of said processes on said luminance component to obtain the luminance component processed image data, and said processed image data is obtained based on said luminance component processed image data.

12. The image processing apparatus according to claim 7, wherein said setting means sets an absolute value of a relevant frequency component as said evaluation value for said frequency component.

13. The image processing apparatus according to claim 9, wherein said setting means sets an absolute value of a relevant frequency component as said evaluation value for said frequency component.

14. An image processing apparatus for obtaining the intended image data by performing noise suppression, sharpness correction, and enlargement processes on image data comprising:
suppressing and correcting means for performing said noise suppression and sharpness correction processes on said image data to obtain the suppressed and corrected image data; and
an enlarging means for performing said enlargement process on said suppressed and corrected image data.

15. The image processing apparatus according to claim 14, wherein said suppressing and correcting means comprises:
an extracting means for extracting at least high frequency and mid-frequency components from image data;
setting means for setting an evaluation value for said extracted high frequency component, then setting a high frequency component gain for emphasizing said extracted high frequency component in accordance with said evaluation value;
a gain adjusting means for adjusting said high frequency component gain by obtaining an edge probability in said extracted mid-frequency component, and in such a way that the lower said edge probability, the lower said high frequency component gain;
a high frequency component adjusting means for adjusting said high frequency component using said high frequency component gain adjusted by said gain adjusting means; and
a combining means for combining said high frequency component adjusted by said high frequency component adjusting means with other frequency components to obtain said suppressed and adjusted image data.

16. The image processing apparatus according to claim 15, wherein said gain adjusting means uses an absolute signal value of said mid-frequency component as said edge probability in said mid-frequency component.

17. The image processing apparatus according to claim 15, wherein
said extracting means is a decomposing means for decomposing image data into at least high frequency, mid-frequency, and low frequency components;
said setting means is a setting means for setting an evaluation value for said extracted mid-frequency component, then setting a mid-frequency component gain in accordance with said evaluation value, as well as for setting said high frequency component gain;
a mid-frequency component suppressing means is further provided for performing a suppression process for suppressing said mid-frequency component using said mid-frequency component gain; and
said combining means is a combining means for combining said adjusted high frequency component and said suppressed mid-frequency component with other frequency components.

18. The image processing apparatus according to claim 16, wherein
said extracting means is a decomposing means for decomposing image data into at least high frequency, mid-frequency, and low frequency components;
said setting means is a setting means for setting an evaluation value for said extracted mid-frequency component, then setting a mid-frequency component gain in accordance with said evaluation value, as well as for setting said high frequency component gain;
a mid-frequency component suppressing means is further provided for performing a suppression process for suppressing said mid-frequency component using said mid-frequency component gain; and
said combining means is a combining means for combining said adjusted high frequency component and said suppressed mid-frequency component with other frequency components.

19. A program for use with a computer for implementing image processing comprising:
an extraction process for extracting at least high frequency and mid-frequency component from image data;
a setting process for setting an evaluation value for said high frequency component, then setting a high frequency component gain for adjusting said extracted high frequency component in accordance with said evaluation value;
a gain adjustment process for adjusting said high frequency component gain by obtaining an edge probability in said extracted mid-frequency component, and in such a way that the lower said edge probability, the lower said high frequency component gain;
a high frequency component adjustment process for adjusting said high frequency component using said high frequency component gain adjusted by said gain adjustment process; and
a combining process for combining said adjusted high frequency component with other frequency components to obtain the processed image data.

20. A program for use with a computer for implementing an image processing comprising:
a procedure for performing noise suppression and sharpness correction processes on image data to obtain suppressed and corrected image data; and
a procedure for performing an enlargement process on said suppressed and corrected image data to obtain the intended image data.
